(19) United States
(12) Patent Application Publication
(10) Pub. No.: US 2023/0029221 A1
(43) Pub. Date: Jan. 26, 2023

(54) GALLOPING MONITORING OF OVERHEAD TRANSMISSION LINES USING DISTRIBUTED FIBER OPTIC SENSING

(71) Applicant: NEC Laboratories America, Inc., Princeton, NJ (US)

(72) Inventors: Yangmin DING, North Brunswick, NJ (US); Sarper OZHARAR, Princeton, NJ (US); Yue TIAN, Princeton, NJ (US); Ting WANG, West Windsor, NY (US); Yuandu XU, Jersey City, NJ (US)

(73) Assignee: NEC LABORATORIES AMERICA, INC, Princeton, NJ (US)

(21) Appl. No.: 17/869,785

(22) Filed: Jul. 20, 2022

Related U.S. Application Data
(60) Provisional application No. 63/224,538, filed on Jul. 22, 2021.

(51) Int. Cl. G01D 5/353; G01H 9/00

(52) U.S. Cl. CPC G01D 5/35361; G01H 9/004

(57) ABSTRACT

Systems, and methods for monitoring galloping of overhead transmission lines using distributed fiber optic sensing (DFOS) in combination with frequency domain decomposition (FDD) (frequency domain) algorithms/methods. A DFOS interrogator/analyzer is used to collect real-time data for pre-processing. The pre-processed data is further processed by processing algorithms, which provide results to a graphical user interface or other reporting mechanisms that provide real-time monitoring, alarming, and reporting of the galloping status of the overhead transmission lines.

### CROSS REFERENCE TO RELATED APPLCIATIONS

This application claims the benefit of U.S. Provisional Patent Application Ser. No. 63/224,538 filed 22 Jul. 2021 the entire contents of which is incorporated by reference as if set forth at length herein.

### TECHNICAL FIELD

This disclosure relates generally to electrical power transmission lines and facilities. More particularly, it describes systems and methods for monitoring galloping transmission lines using distributed fiber optic sensing (DFOS).

### BACKGROUND

As those skilled in the art will readily understand and appreciate, galloping is a wind-induced, high amplitude, periodic, predominately vertical oscillation that can affect all types of power line, used in overhead distribution and transmission. Galloping places extra stresses on poles, towers, and crossarms sometimes causing them to break. Galloping of transmission lines can increase the tension between towers, which may eventually result in significant damage to the tower(s).

In addition, when galloping occurs, because of their motion, the lines (cables) from two different phases may become too close to one another, thus resulting in repeated short circuits that may eventually force operators to remove it from service.

Presently, several techniques have been developed/deployed for galloping monitoring for power lines. For example, video and image processing-based methods have been developed to detect spatial parameters of transmission lines. Other techniques combine a Fiber Bragg grating (FBG) sensor with attitude sensors to achieve a real time-time horizontal tension monitor of a transmission line and subsequent determination of galloping amplitude based on a relationship between galloping amplitude and horizontal tension. Unfortunately, such techniques require additional sensors, which adds cost and complexity to the systems and are susceptible to environmental conditions such as rain, wind, etc., which may cause interruption of galloping monitoring.

### SUMMARY

An advance in the art is made according to aspects of the present disclosure directed to systems, and methods for monitoring galloping of overhead transmission lines using distributed fiber optic sensing (DFOS) with frequency domain decomposition (FDD) (frequency domain) algorithms/methods.

In sharp contrast to the prior art, systems, and methods according to aspects of the present disclosure utilize a DFOS interrogator/analyzer to collect real-time data for pre-processing. The pre-processed data is further processed by processing algorithms, which provide results to a graphical user interface or other reporting mechanisms that provide real-time monitoring, alarming, and reporting of the galloping status of the overhead transmission lines.

### BRIEF DESCRIPTION OF THE DRAWING

A more complete understanding of the present disclosure may be realized by reference to the accompanying drawing in which:

FIG. 1 is a schematic diagram of an illustrative distributed fiber optic sensing system according to aspects of the present disclosure;

FIG. 2 is a schematic diagram illustrating a galloping power line suspended from a transmission tower according to aspects of the present disclosure;

FIG. 3 is a schematic flow diagram showing illustrative operations of a galloping power line monitoring method according to aspects of the present disclosure;

FIG. 4(A) is a plot showing illustrative ambient data captured by distributed acoustic sensing (DAS) according to aspects of the present disclosure;

FIG. 4(B) is a plot showing illustrative galloping data captured by DAS according to aspects of the present disclosure;

FIG. 5(A) is a plot illustrating frequency component decomposition of ambient data according to aspects of the present disclosure;

FIG. 5(B) is a plot illustrating frequency component decomposition of galloping data according to aspects of the present disclosure;

FIG. 6 is a schematic diagram showing illustrative features associated with systems and methods according to aspects of the present disclosure;

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Fiber optic sensing measures changes in “backscattering” of light occurring in an optical sensing fiber when the sensing fiber encounters vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

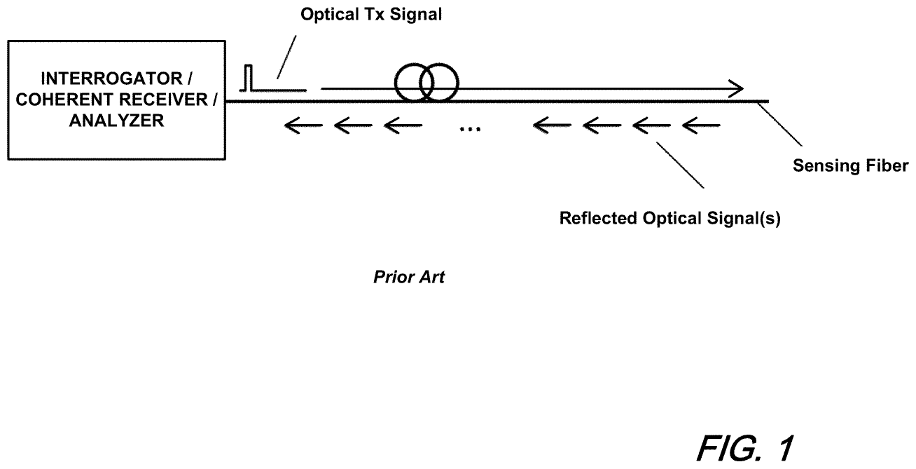

A schematic diagram illustrating the generalized arrangement and operation of a distributed fiber optic sensing system including artificial intelligence analysis and cloud storage/service is shown in FIG. 1. With reference to FIG. 1 one may observe an optical sensing fiber that in turn is connected to an interrogator. As is known, contemporary interrogators are systems that generate an input signal to the fiber and detects/analyzes reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes the interrogator that periodically generates optical pulses (or any coded signal) and injects them into an optical fiber. The injected optical pulse signal is conveyed along the optical fiber.

At locations along the length of the fiber, a small portion of signal is scattered/reflected and conveyed back to the interrogator. The scattered/reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Distributed Acoustic Sensing (DAS)/Distributed Vibrational Sensing (DVS) systems detect vibrations and capture acoustic energy along the length of optical sensing fiber. Advantageously, existing, traffic carrying fiber optic networks may be utilized and turned into a distributed acoustic sensor, capturing real-time data. Classification algorithms may be further used to detect and locate events such as leaks, cable faults, intrusion activities, or other abnormal events including both acoustic and/or vibrational.

Various DAS/DVS technologies are presently used with the most common being based on Coherent Optical Time Domain Reflectometry (C-OTDR). C-OTDR utilizes Rayleigh back-scattering, allowing acoustic frequency signals to be detected over long distances. An interrogator sends a coherent laser pulse along the length of an optical sensor fiber (cable). Scattering sites within the fiber cause the fiber to act as a distributed interferometer with a gauge length like that of the pulse length (e.g. 10 meters). Acoustic/mechanical disturbance acting on the sensor fiber generates microscopic elongation or compression of the fiber (micro-strain), which causes a change in the phase relation and/or amplitude of the light pulses traversing therein.

Before a next laser pulse is be transmitted, a previous pulse must have had time to travel the full length of the sensing fiber and for its scattering/reflections to return. Hence the maximum pulse rate is determined by the length of the fiber. Therefore, acoustic signals can be measured that vary at frequencies up to the Nyquist frequency, which is typically haft of the pulse rate. As higher frequencies are attenuated very quickly, most of the relevant ones to detect and classify events are in the lower of the 2 kHz range.

As we shall show and describe and as already noted, our inventive systems and methods automatically detect/interpret vibration signals resulting from DFOS operation using deployed fiber optic sensor cables to detect/locate cable vibrations caused by—for example—galloping transmission lines/facilities operating sufficiently proximate to the deployed fiber optic sensor cable.

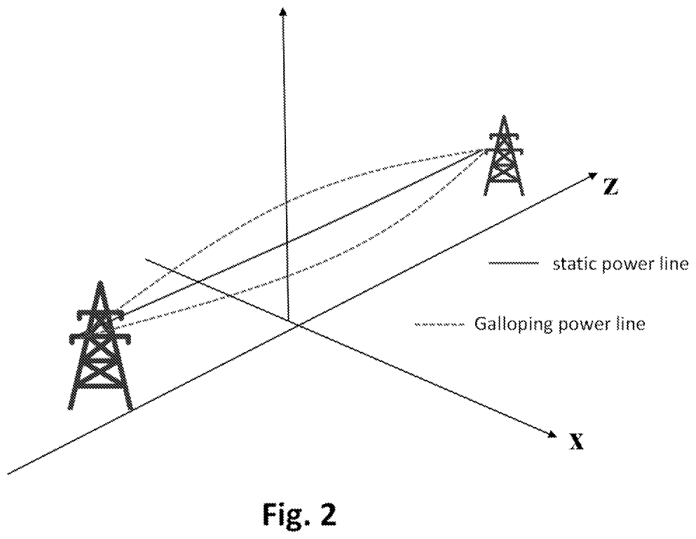

FIG. 2 is a schematic diagram illustrating a galloping power line suspended from a transmission tower according to aspects of the present disclosure. As noted previously, galloping is wind-induced, high amplitude, periodic, predominately vertical oscillation (as depicted in FIG. 2) that can affect all types of power lines, used in overhead distribution and transmission. Galloping puts extra stress on poles, towers and crossarms, sometimes causing them to break. The galloping of transmission lines can increase the tension between the towers which may eventually result in significant damage to the tower. As illustratively depicted in this figure, the power line is shown statically, and then when it is galloping. Not specifically shown in the figure, optical telecommunications fiber optic cable(s) may be co-located with the power lines and suspended from the same pole(s) and/or tower(s).

As we shall show and describe, our real-time data collection and streaming employing distributed fiber sensing turns existing telecommunication cables into a distributed sensor to capture the dynamic responses of the transmission wires, which enables real-time data collection and streaming. The affected length of the cable route can also be interpreted in real-time.

As mentioned previously, galloping is a high amplitude periodic predominately vertical oscillation. In the frequency domain, galloping is a low frequency (from 0.1 to 1 Hz) event. These characteristics present a unique vibration pattern that can be interpreted from time-series data (high amplitude, periodic) and in the frequency domain (forced vibration of 0.1 to 1 Hz) with time/frequency domains. According to aspects of the present disclosure, we employ frequency domain decomposition (FDD) for low-frequency analysis.

A complementary graphical user interface (GUI) can advantageously provide end-users invaluable visibility into distribution and transmission line status, helping to identify galloping, and reduce any bottlenecks, downtime, while increasing efficiency of troubleshooting activities.

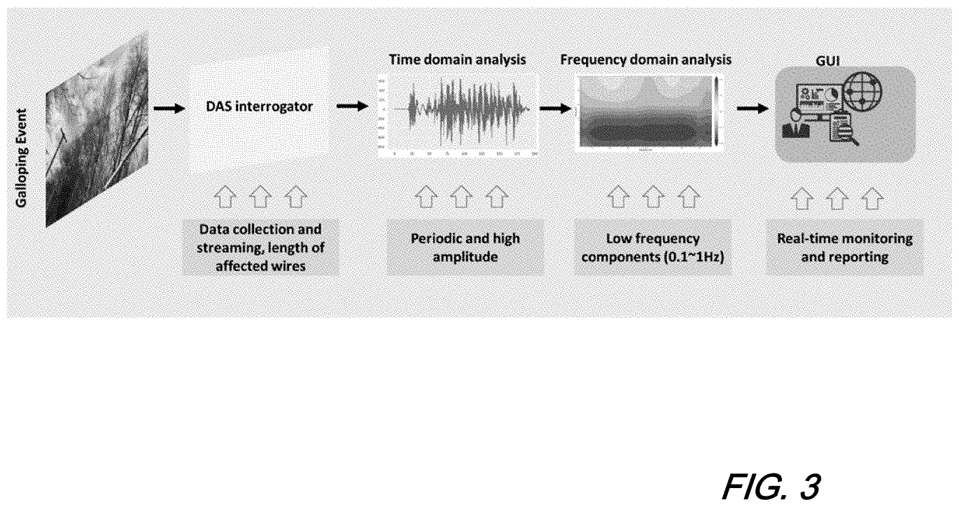

FIG. 3 is a schematic flow diagram showing illustrative operations of a galloping power line monitoring method according to aspects of the present disclosure. With reference to this figure, it may be observed that when galloping occurs on power lines, the galloping causes vibrational excitation of sufficiently proximate DFOS sensor cables—that may advantageously be live optical telecommunications facilities. As such, vibrational data resulting from the galloping is conveyed via the optical telecommunication cables (in distribution lines) or optical ground wire (OPGW) (in transmission lines) through operation of a DAS interrogator and simultaneously, an affected wire length and possible location can be interpreted through the waterfall image(s) generated from the DAS data.

Once vibrational data is received (either locally at a DAS analysis system or a cloud-based system) a time-domain analysis is performed on the data.

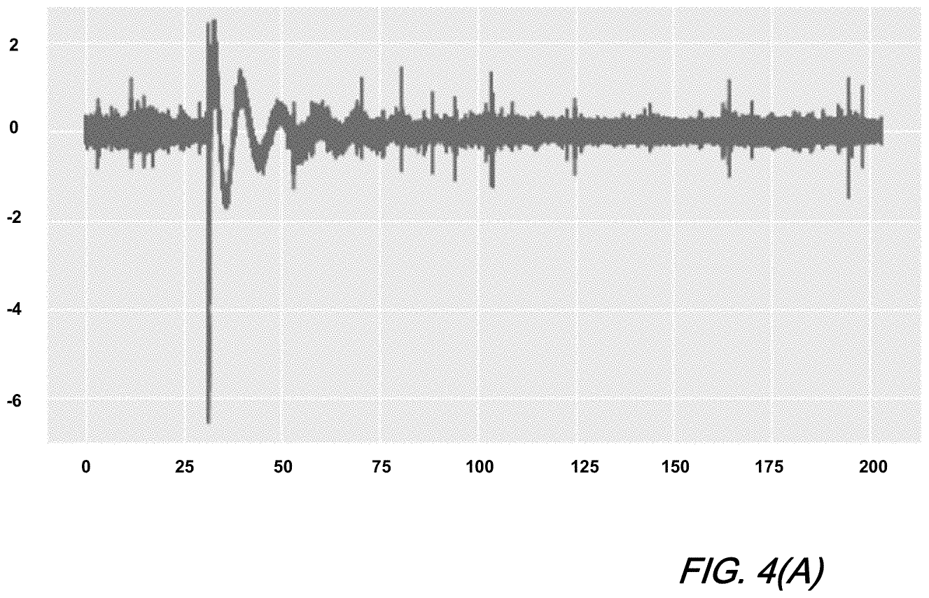

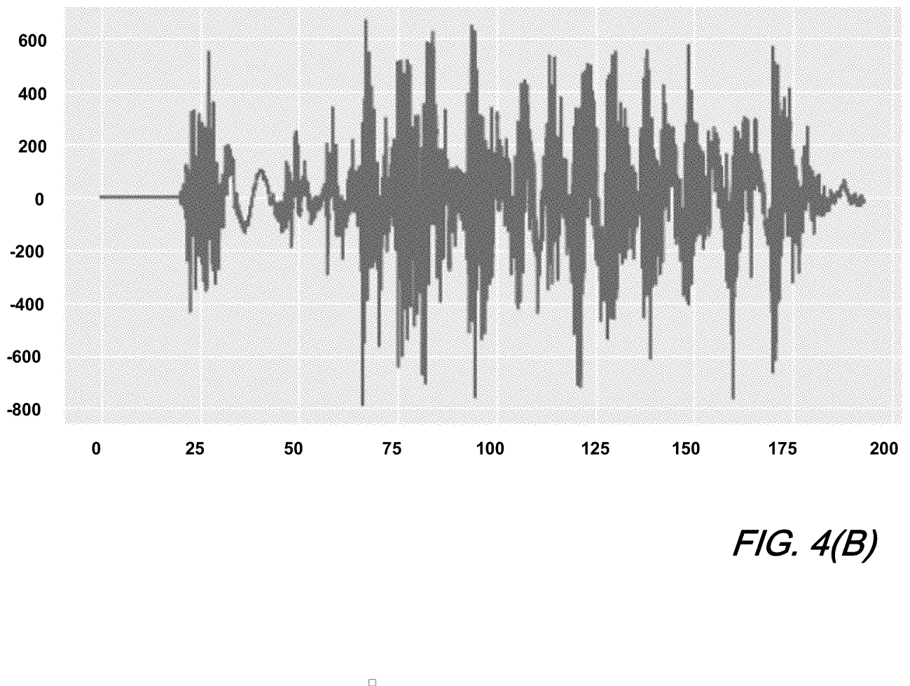

FIG. 4(A) is a plot showing illustrative ambient data captured by distributed acoustic sensing (DAS) according to aspects of the present disclosure.

FIG. 4(B) is a plot showing illustrative galloping data captured by DAS according to aspects of the present disclosure.

As may be observed, these figures illustrate time-domain representations of ambient data (normal condition) and galloping condition of a single point, which is randomly picked up in an optical fiber sensor route. As may be further observed from the plot shown in the figures, a galloping time series data plot shows a large amplitude (above 200 times larger) as compared with data collected in ambient conditions. As will be understood and appreciated by those skilled in the art, this provides definitive indication of the effectiveness of systems and methods according to the present disclosure for identifying galloping transmission lines based on time series data generated via DFOS.

After preliminary analysis in the time domain is completed, the data is further processed in the frequency domain. We apply frequency domain decomposition analysis to the affected. The frequency component analysis will provide a more accurate identification of galloping events.

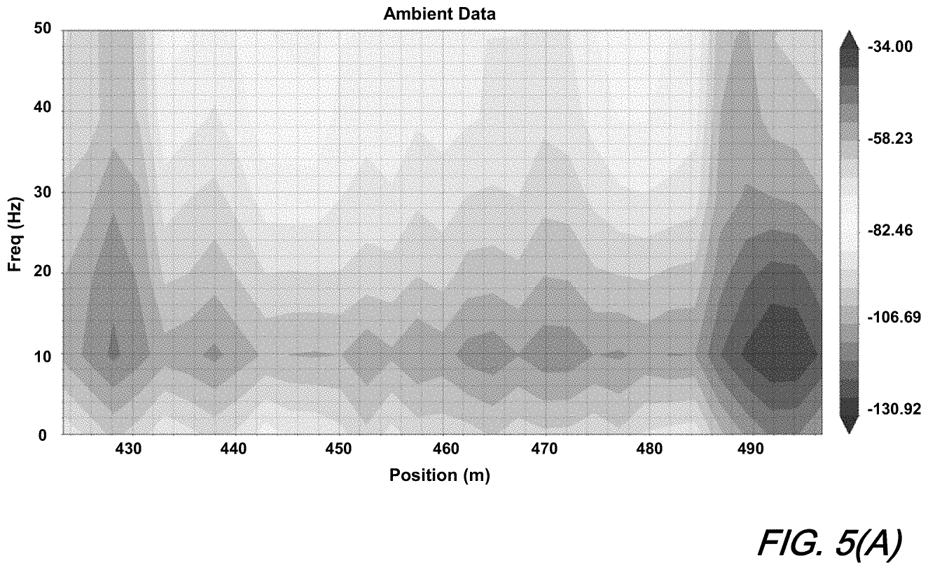

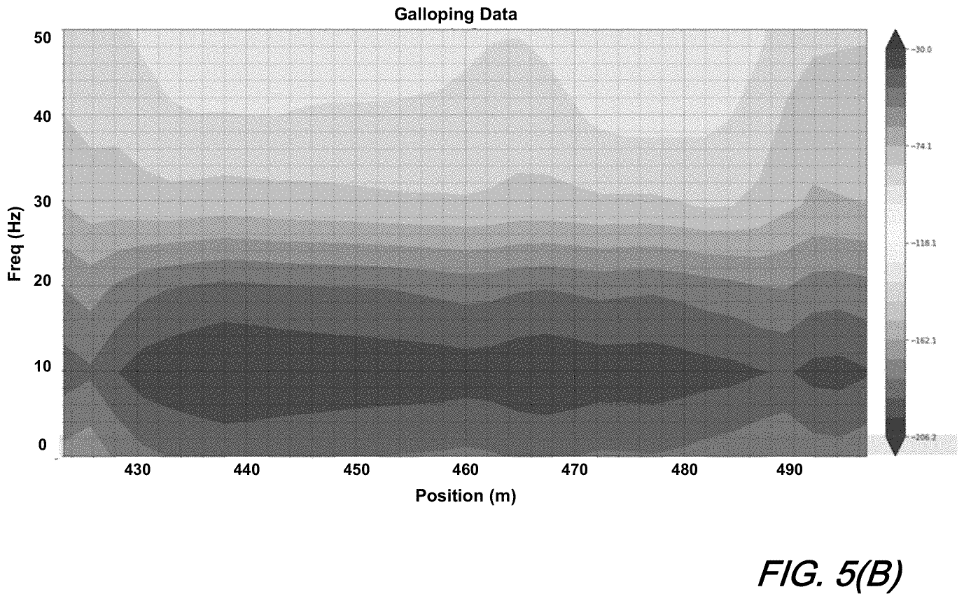

FIG. 5(A) is a plot illustrating frequency component decomposition of ambient data according to aspects of the present disclosure.

FIG. 5(B) is a plot illustrating frequency component decomposition of galloping data according to aspects of the present disclosure.

As we can see from the results shown in these figures, the energy of low-frequency components (0.1 Hz to 1 Hz) is significantly reinforced when galloping occurs.

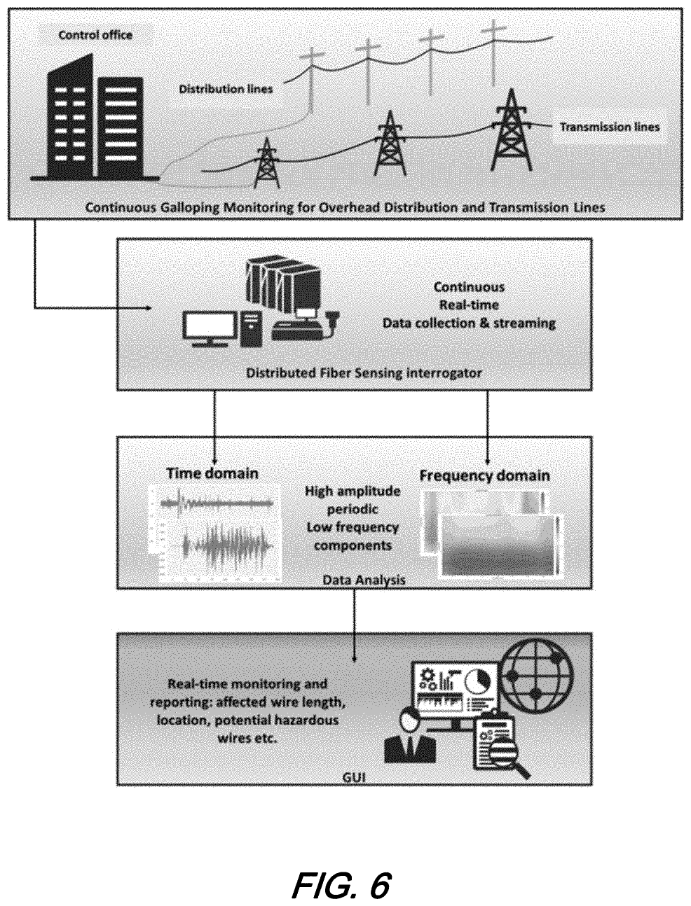

FIG. 6 is a schematic diagram showing illustrative features associated with systems and methods according to aspects of the present disclosure. As schematically illustrated in this figure, the continuous galloping monitoring for overhead distribution and transmission lines is performed using DFOS systems wherein an optical fiber sensing cable(s) are sufficiently proximate to the overhead lines to effectively detect vibration excitations induced into the optical fiber sensor cable when the overhead lines undergo galloping.

Operationally, continuous, real-time data collection and streaming is provided by the DFOS system including the DFOS sensor cable(s) in optical communication with the DFOS interrogator that may be advantageously located in a central or other control office.

From the collected DFOS data and generated waterfall plots, time domain and frequency domain data analysis is performed and both high amplitude periodic and low frequency components associated with the overhead lines are determined. From such determinations, real-time monitoring and reporting including affected wire length(s), location(s), and potential hazard(s) and alarms may be provided.

Operationally, the following procedure may be followed according to aspects of the present disclosure.

Step 1: connect a DAS interrogator to an aerial cable of distribution lines or OPGW cable of transmission lines and collect the vibrational data along a target route. Data quality check-up, low pass filtering, windowing will also be applied to confirm the validity of the raw data;

Step 1: Localize poles or transmission towers between the target route In this step, the GPS location is recorded and will be uploaded to the cloud. This will provide information for quick localization of the affected wires when galloping occurs.

Step 3: Perform time-domain analysis to capture the features (high amplitude, periodic signal, and usually long-lasting time) of galloping in the time domain. Simultaneously, the length of the affected wire will be calculated as well.

Step 4: Perform frequency domain analysis. Once a suspicious galloping event is captured from Step 3, the data is imported to the frequency domain decomposition model for further confirmation of a low-frequency component of 0.1 Hz to 1 Hz.

Step 5: A GUI provides real-time monitoring and reporting of the galloping status. One of the modules of the GUI can provide the frequency of the galloping event of a wire, which can help utility providers identify which wires pose potential galloping hazardous.

At this point, while we have presented this disclosure using some specific examples, those skilled in the art will recognize that our teachings are not so limited.

Accordingly, this disclosure should be only limited by the scope of the claims attached hereto.

1. A method of galloping monitoring of overhead transmission lines using distributed fiber optic sensing (DFOS), the method comprising:
providing a distributed fiber optic sensing system (DFOS), said system including
a length of optical sensor fiber, wherein at least a portion of the length of the optical sensor fiber is suspended overhead on utility poles/towers;
a DFOS interrogator and analyzer in optical communication with the length of optical sensor fiber, said DFOS interrogator configured to generate optical pulses from laser light, introduce the pulses into the optical fiber and detect/receive Rayleigh reflected signals from the optical fiber, said analyzer configured to analyze the Rayleigh reflected signals and generate location/time waterfall plots from the analyzed Rayleigh reflected signals;
operating the DFOS system and determining time/location of vibration events along the length of the optical sensor fiber and determining the existence of galloping of the optical sensor fiber from the vibration events.

2. The method of claim 1 wherein the optical sensor fiber is located on same utility poles/towers as electrical transmission lines and the DFOS system is configured to determine the existence and location of galloping of the electrical transmission lines.

3. The method of claim 2 wherein the DFOS system is further configured to perform a time domain analysis on data generated from the analyzed Rayleigh reflected signals.

4. The method of claim 3 wherein the DFOS system is further configured to perform a frequency domain analysis on data generated from the analyzed Rayleigh reflected signals.

5. The method of claim 5 wherein the time-domain analysis determines one or more features of galloping in the time domain selected from the group consisting of amplitude, duration, and periodicity.

6. The method of claim 5 wherein the time-domain analyzed data is further analyzed in the frequency domain according to a frequency domain decomposition model that confirms a low frequency component of 0.1 Hz to 1 Hz.
